(19) United States
(12) Patent Application Publication
(10) Pub. No.: US 2026/0092786 A1
(43) Pub. Date: Apr. 2, 2026

(54) LOCALIZATION USING PATH-SPECIFIC TRACKERS FOR AUTONOMOUS OR SEMI-AUTONOMOUS SYSTEMS AND APPLICATIONS

(71) Applicant: NVIDIA Corporation, Santa Clara, CA (US)

(72) Inventors: Jugnu Agrawal, San Jose, CA (US); Jordan Marr, San Jose, CA (US); Yu Sheng, San Diego, CA (US); Amir Akbarzadeh, Alamo, CA (US); Shaun Liu, San Jose, CA (US)

(21) Appl. No.: 18/900,148

(22) Filed: Sep. 27, 2024

(51) Int. Cl. G01C 21/34; G01C 21/00

(52) U.S. Cl. CPC G01C 21/3453; G01C 21/3815

(57) ABSTRACT

In various examples, path-specific trackers may be initialized and used to localize a machine (e.g., an autonomous or semi-autonomous machine or vehicle) with respect to a specific path in an environment. For instance, when the machine passes through a junction of multiple road segments, a respective tracker may be initialized for each road segment, and the trackers may be placed at respective candidate locations along each of the road segments. The candidate locations may represent possible locations of the machine along the road segments. Using various input data, a determination may be made regarding which tracker—or candidate location—most closely corresponds to the actual location of the machine subsequent to the junction. In some examples, the tracker may be selected for tracking the location of the machine along the current road segment while the other trackers may be terminated or otherwise removed.

### BACKGROUND

For an autonomous or semi-autonomous machine (e.g., vehicle) to safely navigate through an environment, the machine may rely on maps—such as navigational, standard definition (SD), and/or high-definition (HD) maps—corresponding to an environment in which the machine intends to operate. For instance, many conventional systems may localize autonomous or semi-autonomous machines by matching features in HD maps with corresponding, perceived features in real environments. However, HD maps are not always available or, where used, may require processing of sensor data from various modalities to align the perception data with the map data. This can be burdensome on processing bandwidth and/or increase the latency of the system beyond real-time or near real-time deployment. As such, in certain scenarios it may be desirable—or in some cases necessary—to localize the autonomous or semi-autonomous machines to features in navigational and/or SD maps. However, because SD maps may include lower levels of detail than HD maps (e.g., no lane number, class, geometry, etc. information, only GNSS-level accuracy or precision (e.g., within 3 meters of being on a certain road, not lane-level localization) as opposed to centimeter level accuracy or precision of HD maps, etc.), accurately localizing autonomous or semi-autonomous machines to SD map features can be challenging in some instances.

### SUMMARY

Embodiments of the present disclosure relate to localization using path-specific trackers for autonomous or semi-autonomous systems and applications. For instance, systems and methods described herein may initialize and use multiple, path-specific trackers to localize a machine (e.g., an autonomous or semi-autonomous machine or vehicle) with respect to a specific path in an environment. As an example, when the machine passes through a junction of multiple road segments, a respective tracker may be initialized for each road segment, and the trackers may be placed at respective candidate locations along each of the road segments. The candidate locations may represent possible locations of the machine along the road segments based on a tracked motion of the machine. Using various inputs from sensors, perception systems, and/or other systems of the machine, a determination may be made regarding which tracker—or candidate location—most closely corresponds to the actual location of the machine subsequent to the junction. In some examples, the tracker may be selected for tracking the location of the machine along the current road segment while the other trackers may be terminated or otherwise removed.

In contrast to conventional systems, the systems of the present disclosure, in some embodiments, are able to accurately localize autonomous or semi-autonomous machines with respect to features included in navigational or SD maps. For instance, by initializing trackers along potential road segments that could be traversed by a machine after passing through a junction, the systems of the present disclosure are able to more accurately determine which road segment the machine is traversing after the junction. Additionally, by computing scores for each of the trackers and/or candidate locations, the systems of the present disclosure are able to determine and indicate when localization results are unavailable or have low confidence. As such, and as described in more detail herein, by performing such processes, the systems of the present disclosure are able to accurately determine locations of machines in an environment without using HD map data, which may facilitate autonomous or semi-autonomous machines to more safely traverse the environment while minimizing or, at least, reducing processing bandwidth and/or latency.

### BRIEF DESCRIPTION OF THE DRAWINGS

The present systems and methods for localization using path-specific trackers for autonomous or semi-autonomous systems and applications are described in detail below with reference to the attached drawing figures, wherein:

FIG. 1 illustrates an example data flow diagram for a process of using path-specific trackers to localize a machine, in accordance with some embodiments of the present disclosure;

FIG. 2 illustrates an example architecture of a tracker that may be used to track the location of a machine, in accordance with some embodiments of the present disclosure;

FIG. 3 illustrates an example visualization of candidate locations that may be determined for a machine, in accordance with some embodiments of the present disclosure;

FIGS. 4A-4C illustrate examples associated with scoring the candidate locations of the machine from the example of FIG. 3, in accordance with some embodiments of the present disclosure;

FIGS. 5A-5C illustrate examples associated with determining whether to update a cached map of an environment, in accordance with some embodiments of the present disclosure;

FIG. 6 illustrates an example of a system that may perform one or more of the processes described herein, in accordance with some embodiments of the present disclosure;

FIG. 7 is a flow diagram illustrating an example of a method for using path-specific trackers to localize a machine after a junction, in accordance with some embodiments of the present disclosure;

FIG. 8 is a flow diagram illustrating an example of a method for determining a location of a machine based on scoring a plurality of candidate locations, in accordance with some embodiments of the present disclosure;

FIG. 9 is a flow diagram illustrating an example of a method for determining a road segment a machine is using after passing through a junction, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

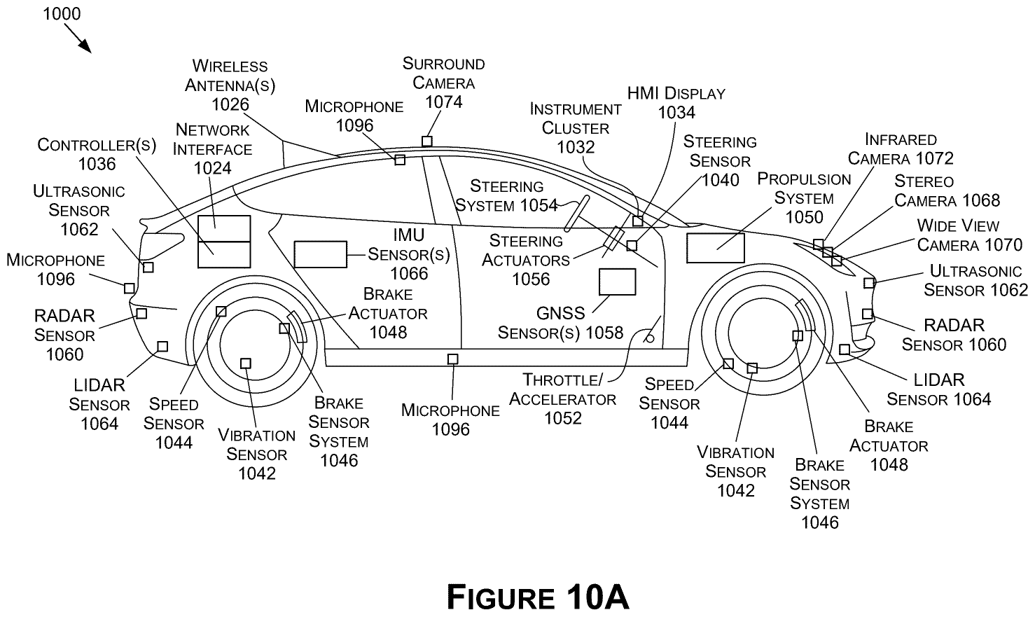

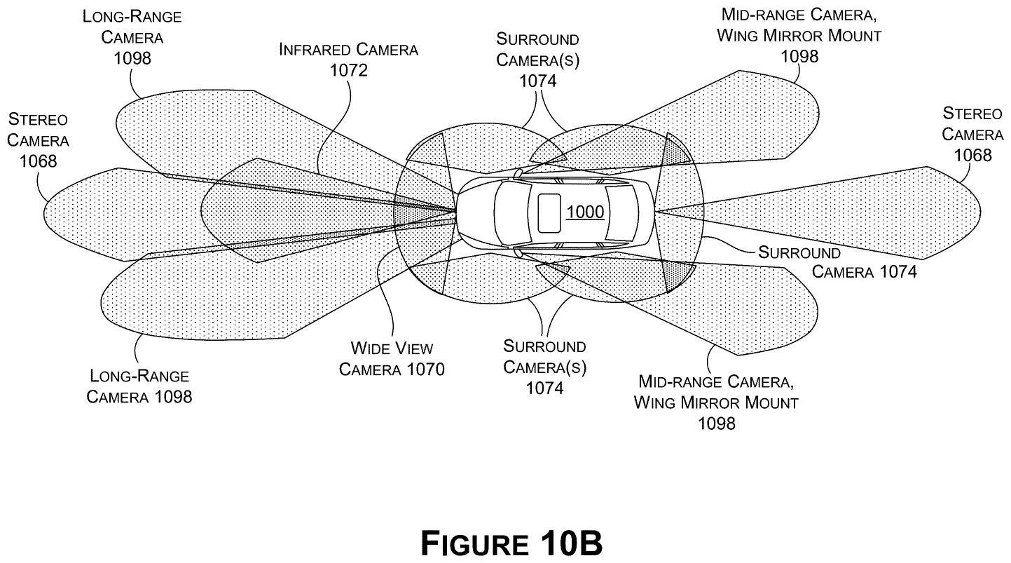

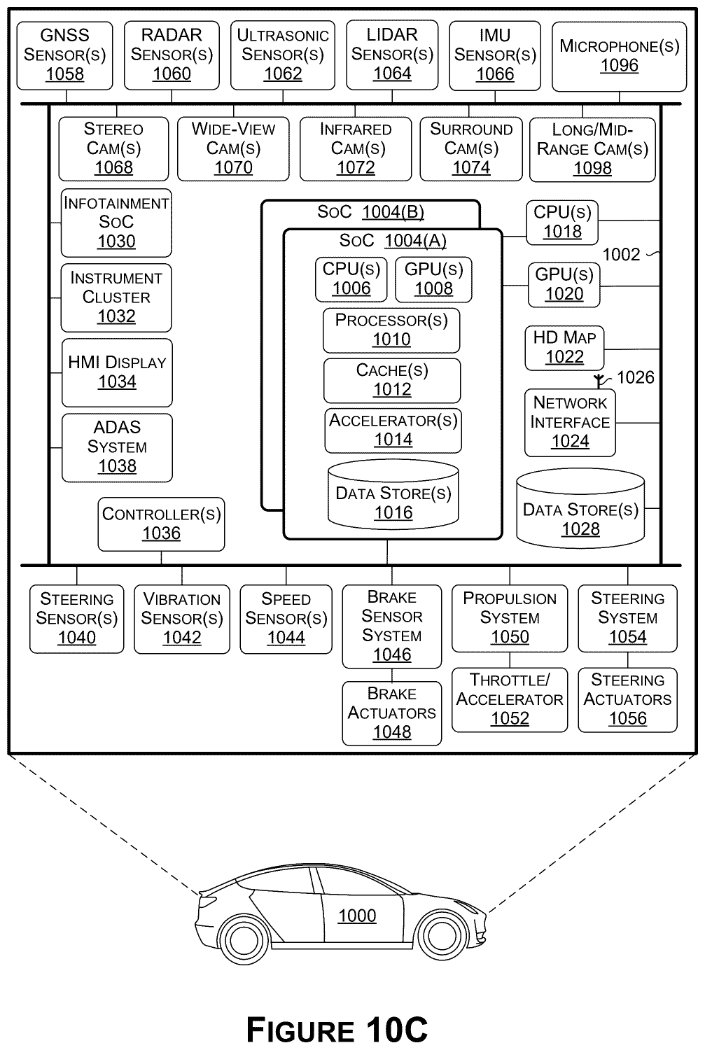

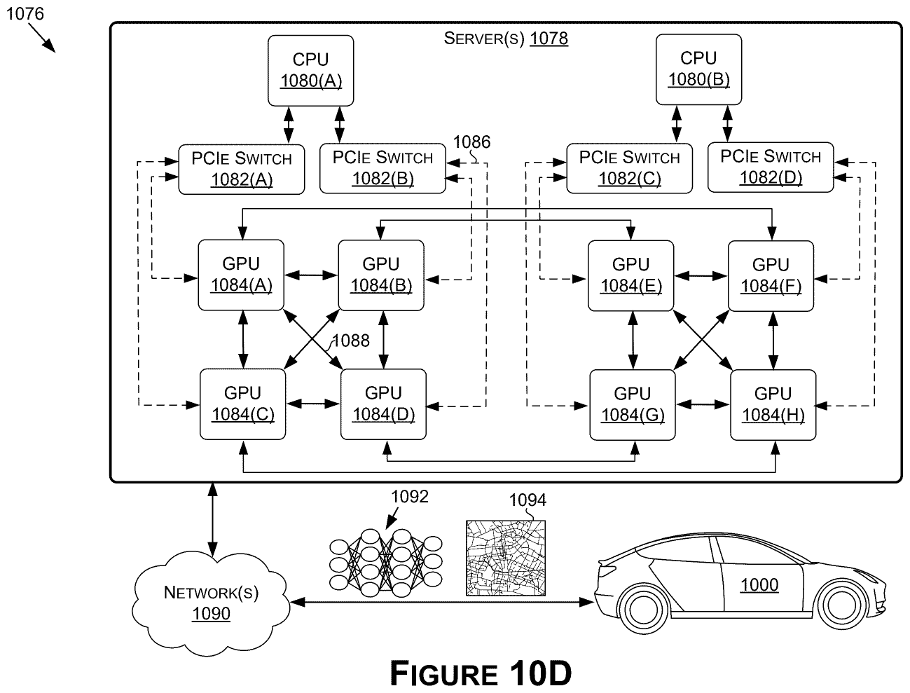

Systems and methods are disclosed related to localization using path-specific trackers for autonomous or semi-autonomous systems and applications. Although the present disclosure may be described with respect to an example autonomous or semi-autonomous vehicle or machine 1000 (alternatively referred to herein as “vehicle 1000,” “ego-vehicle 1000,” “ego-machine 1000,” or “machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to road segment localization, this is not intended to be limiting, and the systems and methods described herein may be used in augmented reality, virtual reality, mixed reality, robotics, security and surveillance, autonomous or semi-autonomous machine applications, and/or any other technology spaces where path localization may be used.

For instance, a system(s) may determine that a machine (e.g., an autonomous or semi-autonomous machine or vehicle) is about to pass through (e.g., is within a threshold distance and/or time from reaching the junction), is passing through (is within a threshold distance or time of the junction), and/or has passed through a junction (e.g., is within a threshold distance or time after passing the junction) associated with a road network in an environment. In some examples, the junction may correspond to an area of the environment where two or more road segments meet or intersect. In various instances, the junction may vary in complexity, from a simple T-intersection or Y-intersection to more intricate designs like roundabouts or multi-lane interchanges. As such, the junction may include a plurality of options for a path of the machine. For instance, the junction may correspond to an intersection of a first road segment, a second road segment, a third road segment, and so forth. Accordingly, at the junction, the machine may select one of the first road segment, the second road segment, the third road segment, and so forth to traverse as part of the path of the machine.

In some instances, the system(s) may determine the presence of the junction and/or the machine's location relative to the junction (e.g., whether the machine is about to pass through, passing through, or passed through the junction) based at least on tracking the location of the machine with respect to a map (e.g., a navigational or SD map) of the environment. For instance, the system(s) may initialize a first tracker (also referred to herein as an “initial tracker”) at an approximate location of the machine with respect to the map based at least on determining an initial position/location of the machine with respect to the map. In some examples, the first tracker may include a Kalman filter for tracking the location of the machine using state variables that are updated by the Kalman filter every frame, every other frame, etc. The state variables may include, in some instances, at least a first state variable corresponding to a road segment identifier, a second state variable corresponding to an offset of the machine with respect to the road segment (e.g., a location of the machine relative to a beginning or end of the road segment), and a third state variable corresponding to a confidence associated with the offset. In some examples, whether the machine has passed through a junction may be determined if, after applying new measurements to the Kalman filter of the first tracker, the offset state has moved past the end of the current road segment and onto a successor road segment.

As described herein, in some examples, based on the determination that the machine passed through the junction, the system(s) may initialize a plurality of trackers to track a plurality of possible locations (also referred to herein as “candidate locations” and/or “candidate poses”) of the machine along one or more of the successor road segments leading away from the junction. For instance, if the junction is a 4-way intersection associated with four road segments and the first tracker moved from a first road segment to a second road segment via the junction, the system(s) may initialize two additional trackers for tracking two possible locations of the machine along the other two successor road segments leading away from the junction (e.g., the road segments leading away from the end of the first road segment and/or beginning of the second road segment).

In some examples, the first tracker may be moved to the successor road segment of the junction that corresponds to a predicted path (e.g., most probable path) of the machine, while the additional trackers may be initialized to track the possible locations along the other successor road segments that are not part of the predicted path. In other words, assume, for example, that at the 4-way intersection the predicted path of the machine is to go straight through the junction from a first road segment to a second road segment. In such an example, the first tracker may be moved, by default, from the first road segment to a first possible location(s) of the machine along the second road segment. The additional trackers, however, may be initialized for tracking possible locations of the machine along a third road segment (e.g., right turn at the junction) and a fourth road segment (e.g., left turn at the junction). For instance, a second tracker may be initialized for tracking a second possible location(s) of the machine along the third road segment and a third tracker may be initialized for tracking a third possible location(s) of the machine along the fourth road segment.

In some instances, the system(s) may compute scores for each of the trackers and/or possible locations of the machine subsequent to the junction. The scores may be indicative of which tracker or possible location corresponds to the actual location of the machine. For instance, in the above example where the junction is a 4-way intersection, the system(s) may compute a first score(s) for the first tracker, a second score(s) for the second tracker, and a third score(s) for the third tracker. In some instances, the system(s) may compute new scores at every epoch and aggregate the scores over a period of time to determine the location of the machine. In some examples, values of the scores may be computed using the same or similar measurements used to update the states of the Kalman filter of the first tracker, such as machine motion (relative motion and global motion), curvature from perception, yaw rate, whether the candidate pose corresponds to (e.g., is located on) on the most probable path of the machine, number of lanes, color/style of lane markings, etc.

As described herein, the system(s) may evaluate the scores to determine which one of the possible locations/trackers corresponds to the actual location of the machine. In some examples, the location/tracker having the highest score that is greater than the other score(s) by more than a threshold may be determined to correspond to the actual location of the machine and may be provided as the localization result. For instance, and continuing the 4-way intersection example from above, the system(s) may determine that the first score(s) associated with the first possible location(s) is greater than the second score(s) and third score(s) associated with the second possible location(s) and third possible location(s), respectively. In such an example, the system(s) may determine that the location of the machine corresponds to the first possible location(s) based at least on the first score(s) being greater than the second score(s) and third score(s). Additionally, in some examples, the system(s) may determine whether one or more differences between the first score(s) and the second and third score(s) meet or exceed the threshold, and the determination that the location of the machine corresponds to the first possible location(s) may be further based on the difference(s) meeting or exceeding the threshold.

In some examples, once one of the scores associated with one of the possible locations is determined to be greater than the other scores by more than the threshold, the system(s) may set the tracker to the prevailing location and remove/terminate the other trackers for the other locations. In some instances, if the prevailing location/tracker is not the initially predicted path or most probable path, the system(s) may reinitialize the tracker (e.g., reinitialize a Kalman filter) at the road segment corresponding to the prevailing location/tracker. In contrast, if the prevailing location/tracker is the initially predicted or most probable path, the system(s) may, in some examples, not need to make any changes as the initial tracker may simply continue its normal operation. In some examples, if the machine travels more than a threshold distance and/or for more than a threshold period of time with multiple possible locations and trackers, and none of the scores meet or exceed the threshold, the system(s) may mark the localization result as unavailable.

In some examples, the system(s) may perform one or more operations associated with the machine based at least on determining the location of the machine with respect to the road segments subsequent to the junction. That is, the system(s) may perform the operation(s) based on determining which road segment the machine is traversing subsequent to the junction. For instance, the operation(s) may be based on one or more features, attributes, etc. associated with the road segment. As an example, if the road segment the machine is traversing is an exit ramp, the system(s) may cause the machine to decelerate. As another example, if the road segment associated with the predicted path of the machine had a low level of curvature, but the machine turned at the junction onto a different road segment with higher curvature, the system(s) may update one or more operating parameters associated with the machine based on the curvature of the different road segment, such as adjusting a maximum speed the machine may operate at. Additionally, or alternatively, the system(s) may plan a path for the machine to follow based on localizing the machine to the specific road segment following the junction.

In at least one embodiment, the system(s) may use the determined location of the machine to update a cached map of the environment. For instance, as the machine traverses the environment, the machine may continuously receive portions of a map (e.g., a navigation, SD map, etc.) to use to traverse the environment. As such, the machine may receive and temporarily store the relevant portions of the map, such as the map portions that correspond to the machine's current and/or future locations. In some examples, once a map portion is deemed to be valid (e.g., for the path of the machine), the machine may cache the map portion until a new map portion is received and the newly received portion is also deemed to be valid. As such, the system(s) may use the determined location of the machine with respect to which road segment the machine is using after a junction to determine whether a newly received map portion is valid and/or whether to update the cached map.

In such instances, if the newly received map portion does not include the road segment the machine is currently using, the system(s) may determine that the newly received map portion is invalid and refrain from updating the cached map. That is, the system(s) may cause the machine to continue to rely on the cached map for navigation as the new map portion is invalid. As another example, if a new map portion does not include a road segment corresponding to the predicted path of the machine, or most probable path of the machine, the system(s) may refrain from updating the cached map. If, however, the new map portion includes all relevant road segments, the system(s) may determine the new map portion is valid and permit the cached map to be updated to the newly received map.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated input data (e.g., map data, perception data, or any other data described herein) may be used to initialize trackers to track possible locations of a machine along different road segments leading away from a junction, and the trackers and/or possible locations may be scored to determine the actual location of the virtual machine with respect to the different road segments within the simulation environment. These simulated operations may be used to test performance of the underlying algorithms, systems, and/or processes prior to deploying them in the real-world. In some instances, the simulation may be used to generate synthetic training data—e.g., perception and/or map training data indicative of road segments and junctions within the simulation. The synthetic training data (in addition to or alternatively from real-world data) may then be processed to localize a machine with respect to a specific path following a junction, such as localizing a machine (e.g., a robot) in a warehouse to a specific path in the warehouse after the machine passed through a junction, for example. In any example, such as where a simulation environment is used for testing, validation, training, etc., the simulation environment and/or associated training data may be rendered or otherwise generated using one or more light transport algorithms—such as ray-tracing and/or path-tracing algorithms.

In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications. In some examples, the simulation environment may include a digital twin of a real environment, such as a digital twin of a specific stretch of roadway, a warehouse, a data center, an airport, a geographic area, a marine area, or any other real environment where autonomous or semi-autonomous machines may operate.

In some embodiments, teleoperation or remote control of a vehicle or other machine may be performed using a remote control or teleoperation system. For example, the systems and methods described herein may be used to identify lane lines, road boundary lines, longitudinal features, potential paths, etc. that may be included in a visualization or mapping of an environment to aid a remote operator in controlling—or providing waypoints or other indications of control or navigation—an autonomous or semi-autonomous machine through an environment.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

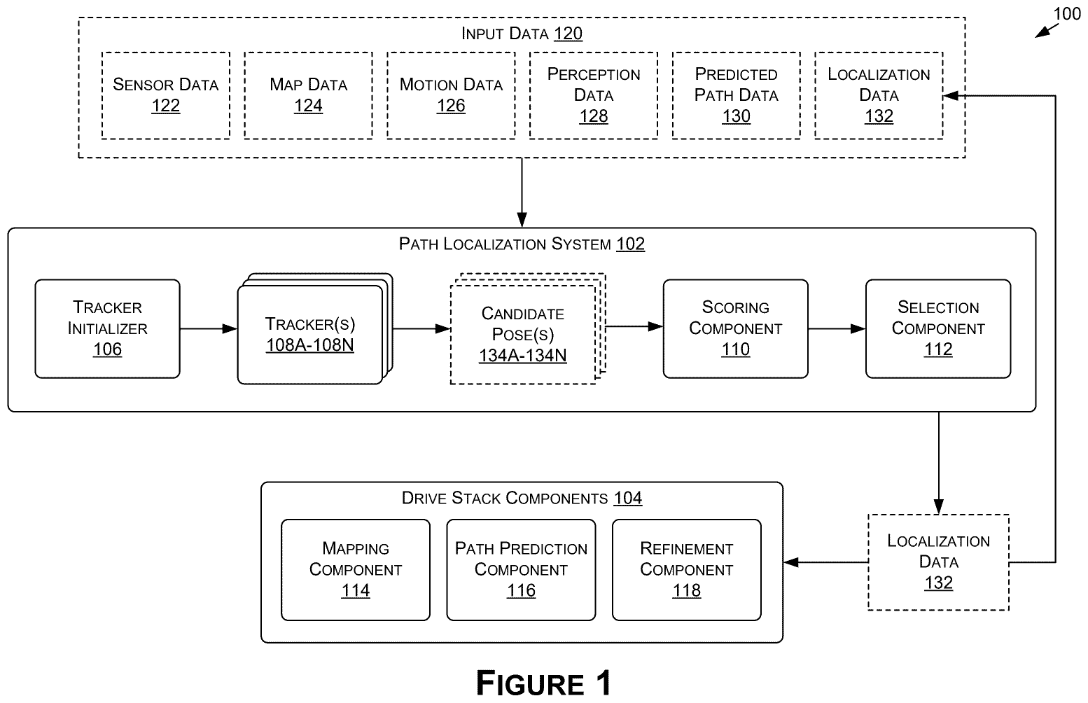

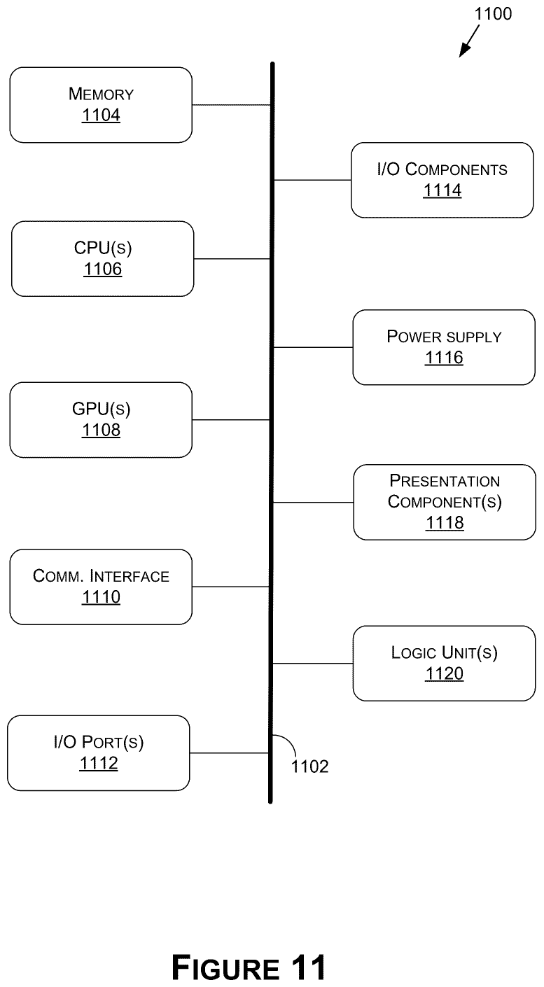

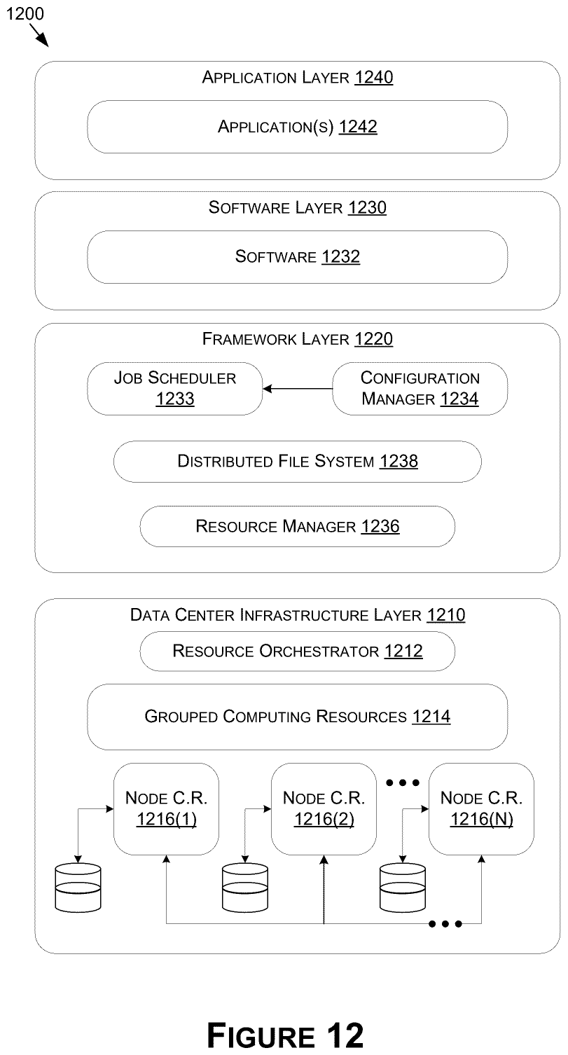

With reference to FIG. 1, FIG. 1 illustrates an example data flow diagram for a process 100 of using path-specific trackers to localize a machine, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

The process 100 may be implemented using, amongst additional or alternative components, a path localization system 102 and drive stack components 104. The path localization system 102 may include a tracker initializer 106, one or more trackers 108A-108N (where “N” may represent any number), a scoring component 110, and a selection component 112. The drive stack components 104 may include a mapping component 114, a path prediction component 116, and a refinement component 118.

As an overview, the process 100 may include the path localization system 102 receiving input data 120, which may include one or more of sensor data 122, map data 124, motion data 126, perception data 128, predicted path data 130, and/or localization data 132. The tracker initializer 106 may use the input data 120 to initialize the tracker(s) 108A-108N (hereinafter referred to collectively as “trackers 108”) for tracking one or more candidate poses 134A-134N (where “N” may represent any number). The scoring component 110 may evaluate the candidate pose(s) 134A-134N (hereinafter referred to collectively as “candidate poses 134”) using the input data 120 and compute one or more scores corresponding to the candidate poses 134. Based on the score(s), the selection component 112 may select a candidate pose of the candidate poses 134 that most closely corresponds to an actual pose of a machine, and/or select a tracker of the trackers 108 that is tracking the candidate pose. Using the selected tracker and/or candidate pose, the path localization system 102 may output the localization data 132, which may indicate a location, pose, etc. of the machine with respect to a specific road segment in an environment. The drive stack components 104 may use the localization data 132 to perform various operations. For instance, the mapping component 114 may use the localization data 132 to determine whether map data is valid, the path prediction component 116 may use the localization data 132 to predict a path of the machine (e.g., a most probable path), and/or the refinement component 118 may use the localization data 132 to, among other things, update or refine a trajectory of the machine, update or refine operational parameters of the machine (e.g., maximum/minimum speed constraints, etc.).

As shown, the input data 120 may include the sensor data 122. The sensor data 122 may correspond to one or more modalities of sensor data, such as LiDAR data generated using one or more LiDAR sensors, RADAR data generated using one or more RADAR sensors, image data generated using one or more image sensors (e.g., cameras), ultrasonic data generated using one or more ultrasonic sensors, GPS data generated using one or more GPS sensors, inertial data generated using one or more inertial measurement units (IMUs), or any other type of sensor data. In some examples, the sensor data 122 may include raw sensor data, pre-processed sensor data, and/or processed sensor data. For example, the sensor data 122 may be captured in one format (e.g., RCCB, RCCC, RBGC, etc.), and then converted (e.g., during pre-processing of the sensor data) to another format. In some other examples, the sensor data 122 may be provided as input to a sensor data or image data pre-processor (not shown) to generate pre-processed sensor data. For example, in the context of image data, many types of images or formats may be used as inputs; for example, compressed images such as in Joint Photographic Experts Group (JPEG), Red Green Blue (RGB), or Luminance/Chrominance (YUV) formats, compressed images as frames stemming from a compressed video format (e.g., H.264/Advanced Video Coding (AVC), H.265/High Efficiency Video Coding (HEVC), VP8, VP9, Alliance for Open Media Video 1 (AV1), Versatile Video Coding (VVC), or any other video compression standard), raw images such as originating from Red Clear Blue (RCCB), Red Clear (RCCC) or other type of imaging sensor.

In some examples, the map data 124 may include SD map data representing a navigational or SD map of the environment (e.g., a map with less detail than an HD map, such as a map that does not include identifiers or indicators of how many lanes are on each road, classifiers for each lane, etc.). The map data 124 may indicate a topology of at least a portion of a road network the machine is using. For instance, the map data 124 may indicate approximate locations of junctions in the environment where road segments of the road network deviate from one another. The map data 124 may also indicate approximate angles of the road segments, lengths of the road segments, starting and ending locations of the road segments, geometries of the road segments, curvatures of the road segments, etc. In some instances, the map 124 data may be continuously updated based on the location of the machine. That is, the machine may continuously receive updated map data 124 for relevant portions of the map corresponding to areas that are proximate the location of the machine. For instance, the map data 124 may represent a map of the next 100 meters of road segment(s) ahead of the machine, a map of the current road segment of the machine and the next junction point and successor road segments ahead of the machine, the current road segment only, etc.

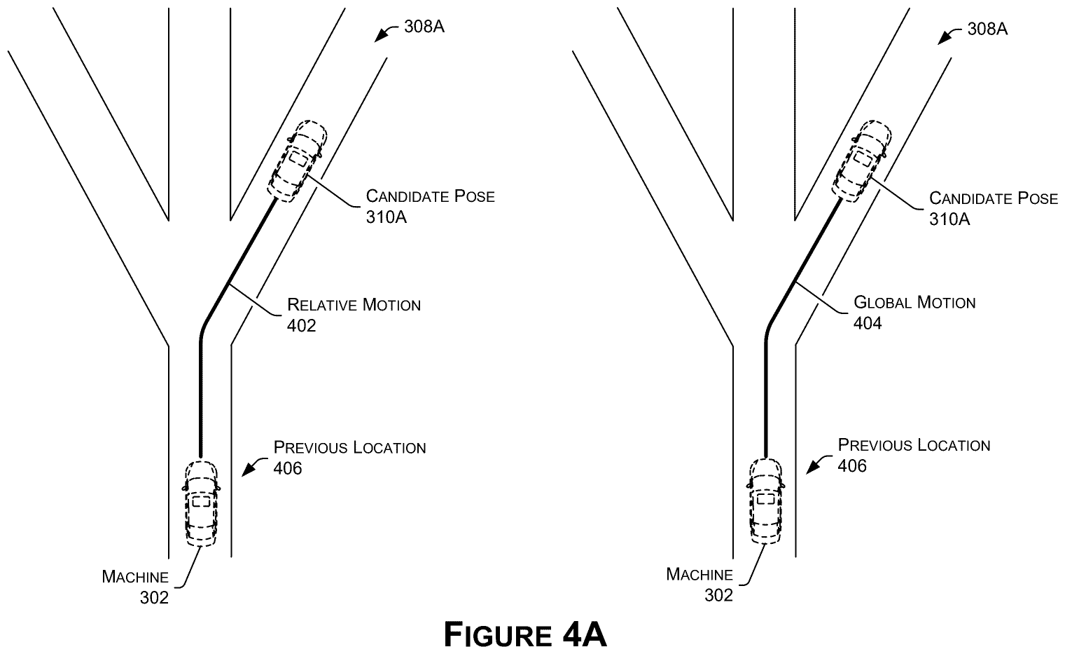

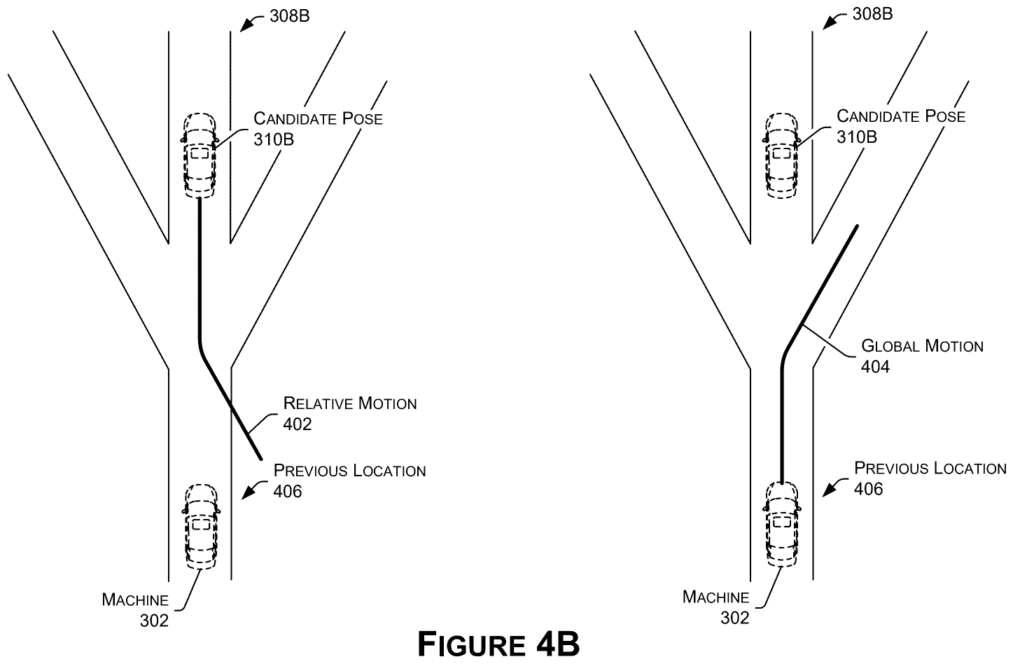

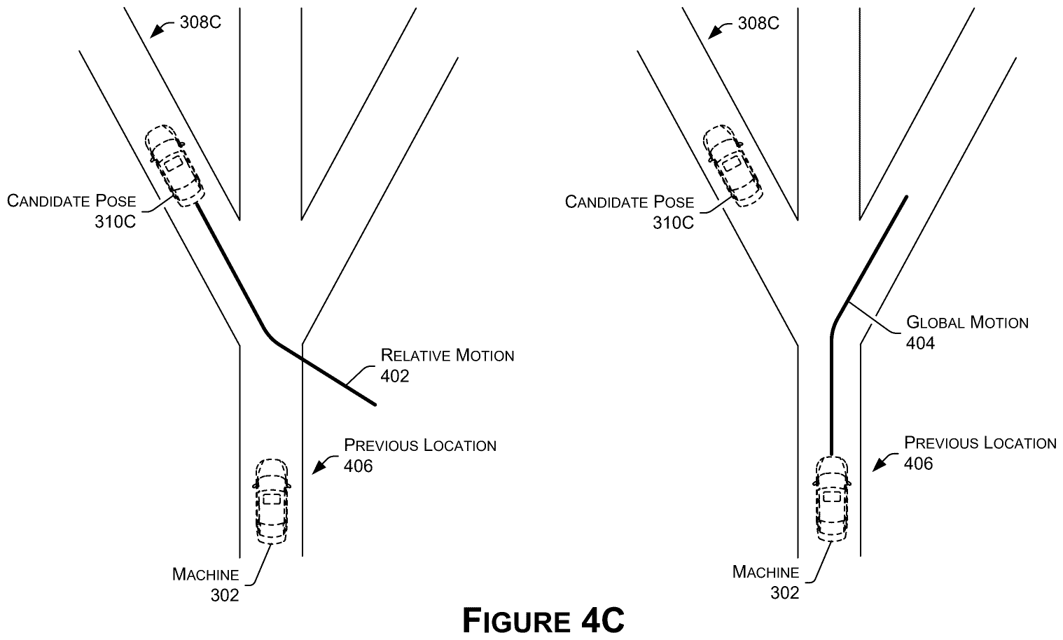

In some examples, the motion data 126 may include relative motion data and/or global motion data. For instance, the relative motion data may indicate a rotation(s) and/or a translation(s) of the machine relative to the machine's current pose, orientation, and/or location. That is, the relative motion data may indicate a tracked path of the machine, however the orientation of the tracked path may be based on the pose of the machine. Examples of relative motions of a machine are shown and described in greater detail herein with respect to the examples of FIGS. 4A-4C. In contrast, the global motion data may indicate the motion of the machine relative to a coordinate system, such as a GPS coordinate system including latitude and longitude. The global motion data may be used to represent a path of the machine using a series of latitude and longitude points and an orientation or pose of the machine. As such, the global motion data or global motion path of the machine may be determined using GPS data, IMU data, and odometry data collected over multiple timestamps.

The perception data 128 may indicate perceived locations of various features in the environment. The perception data 128 may be determined or generated using a perception system (not shown) to process at least the sensor data 122 and/or potentially any other data described herein. For instance, the perception system may receive the sensor data 122 (e.g., LiDAR data, RADAR data, image data, etc.) and process the sensor data 122 to determine locations of objects (e.g., vehicles, pedestrians, obstacles, etc.) and/or other features (e.g., road surfaces, road edges, lane line markings, road surface markings, etc.) in the environment. In some examples, the perception system may include one or more machine learning models for predicting the locations of the objects, features, etc. As such, the sensor data 122 may be applied (e.g., raw or pre-processed) to the machine learning models of the perception system, and the machine learning modes may process and analyze the sensor data 122 to perceive the objects, features, etc. in the environment surrounding the machine. In some examples, the perception data 128 may indicate curvatures of road segments, locations of road segment junctions, road network geometry, or any other attributes or features associated with a driving surface. The perception data 128 may also be indicative of the location of the machine with respect to the road network, road segment, lanes of the road segments, etc.

The predicted path data 130 may indicate a predicted, or most probable path of the machine. For instance, the predicted path may indicate which road segment the machine is likely to use after passing through a junction. In some examples, the predicted path of the machine may be determined based on data indicating an intent of an occupant of the machine. Such data indicating occupant intent may include, but is not limited to, turn signals of the machine, a yaw rate of the machine, a predefined or set route of the machine, or a destination of the machine. The occupant intent may indicate the path of the machine. Additional detail regarding using data indicating occupant intent to determine a predicted path of a machine is described in U.S. patent application Ser. No. 18/811,368, filed on Aug. 21, 2024, the entire contents of which is herein incorporated by reference in its entirety and for all purposes.

The localization data 132 may be determined by the path localization system 102 using the techniques disclosed herein. That is, the localization data 132 output by the path localization system 102 may be fed back into the path localization system 102 as an input for future iterations. The localization data 132 may indicate a location and/or pose of the machine in the environment. For instance, the localization data 132 may indicate an approximate GPS position of the machine and the machine's pose (e.g., orientation and heading) relative to the map of the environment. As such, the localization data 132 may indicate which road segment the machine is operating on and/or where the machine is positioned relative to a start and end of the road segment, in some examples.

In some instances, the localization data 132 may be unavailable. For instance, and as described in further detail herein, in some scenarios a confidence that the machine is positioned along a certain road segment may be below a threshold confidence. That is, in such scenarios, the path localization system 102 and/or one or more of the components therein may be unable to determine whether the machine is positioned along a first path/road segment or positioned along a second path/road segment. In these scenarios, the path localization system 102 may refrain from outputting the localization data 132, or the localization data 132 may indicate that the location of the machine cannot be determined or has been determined with low confidence. In this way, other systems or components of the machine (e.g., the drive stack components 104) may adjust their behavior and outputs accordingly.

As described herein, the process 100 may include the tracker initializer 106 initializing the trackers 108 for tracking the candidate poses 134 of the machine. In some instances, the tracker initializer 106 may initialize the trackers 108 based at least on a determination that the machine passed through a junction. The junction may correspond to an area of the environment where two or more road segments meet or intersect. In various instances, the junction may vary in complexity, from a simple T-intersection or Y-intersection to more intricate designs like roundabouts or multi-lane interchanges. As such, the junction may include a plurality of options for a path of the machine. For instance, the junction may correspond to an intersection of a first road segment, a second road segment, a third road segment, and so forth. Accordingly, at the junction, the machine may select one of the first road segment, the second road segment, the third road segment, and so forth to traverse as part of the path of the machine.

In some instances, the tracker initializer 106 may determine the presence of the junction and/or the machine's location relative to the junction (e.g., whether the machine is about to pass through, passing through, or passed through the junction) based at least on tracking the location of the machine with respect to the map data 124. For instance, prior to the tracker initializer 106 determining the machine passed through the junction, the tracker initializer 106 may have initialized a tracker to track the location of the machine relative to a previous road segment of the road network (e.g., a road segment that the machine used to navigate to the junction). The tracker may have tracked an offset of the machine on the previous road segment, and once the offset indicates the machine was no longer on the road segment and moved to a successor road segment, the tracker initializer 106 may have been invoked to determine whether any new trackers needed to be initialized. For instance, the tracker initializer 106 may initialize the new trackers 108 if the machine passed through a junction having at least two options for a path of the machine.

In some examples, the trackers described herein, such as the trackers 108, may be implemented using Kalman filters. The Kalman filters may track the candidate poses of the machine using state variables that are updated every frame, every other frame, etc. The state variables may include, in some instances, at least a first state variable corresponding to a road segment identifier, a second state variable corresponding to an offset of the machine with respect to the road segment (e.g., a location of the machine relative to a beginning or end of the road segment), a third state variable corresponding to a confidence associated with the offset, and potentially other state variables.

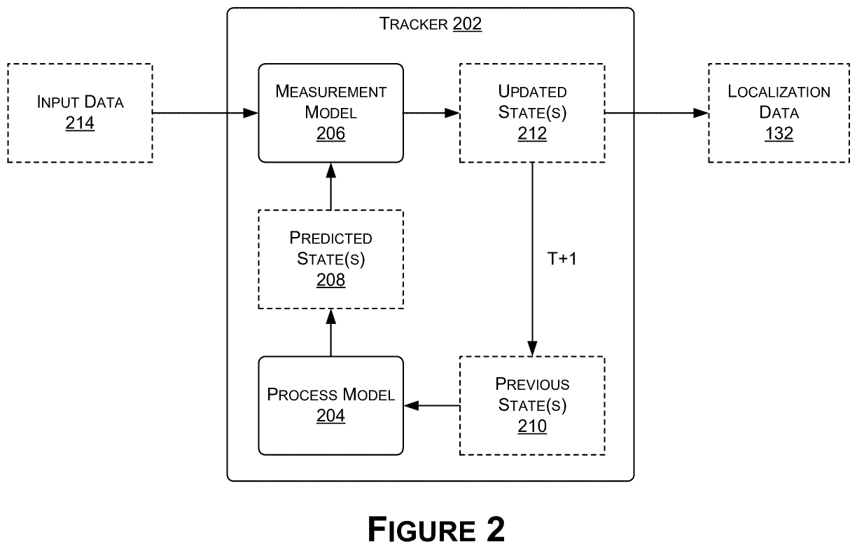

For instance, FIG. 2 illustrates an example architecture of a tracker 202 that may be used to track the location and/or pose of the machine, in accordance with some embodiments of the present disclosure. The tracker 202 may correspond to one or more of the trackers 108. That is, similar to the tracker 202, the trackers 108 may include a Kalman filter architecture that comprises at least a process model 204 and a measurement model 206. The process model 204 may be configured to generate one or more predicted states 208 (e.g., predicted values of state variables) based on one or more previous states 210 of the tracker 202. The measurement model 206 may use input data 214—which may correspond to the input data 120 in the example of FIG. 1—to refine the predicted state(s) 208 and output one or more updated states 212. That is, the measurement model 206 may use the input data 214 to refine one or more values of the state variables predicted by the process model 204 from the previous state(s) 210. In some examples, the updated state(s) 212 may be used by the path localization system 102 to determine the localization data 132.

Referring back to the example of FIG. 1, the process 100 may include the tracker initializer 106 initializing one or more of the trackers 108 to track one or more of the candidate poses 134 (also referred to herein as “candidate locations” and/or “possible locations”) of the machine along one or more successor road segments leading away from the junction. For instance, if the junction has three successor road segments, the tracker initializer 106 may initialize two additional trackers for tracking two candidate poses 134 of the machine along two of the successor road segments leading away from the junction (e.g., the road segments leading away from the end of the first road segment and/or beginning of the second road segment), while the original tracker may continue to track the candidate pose of the machine along the other successor road segment.

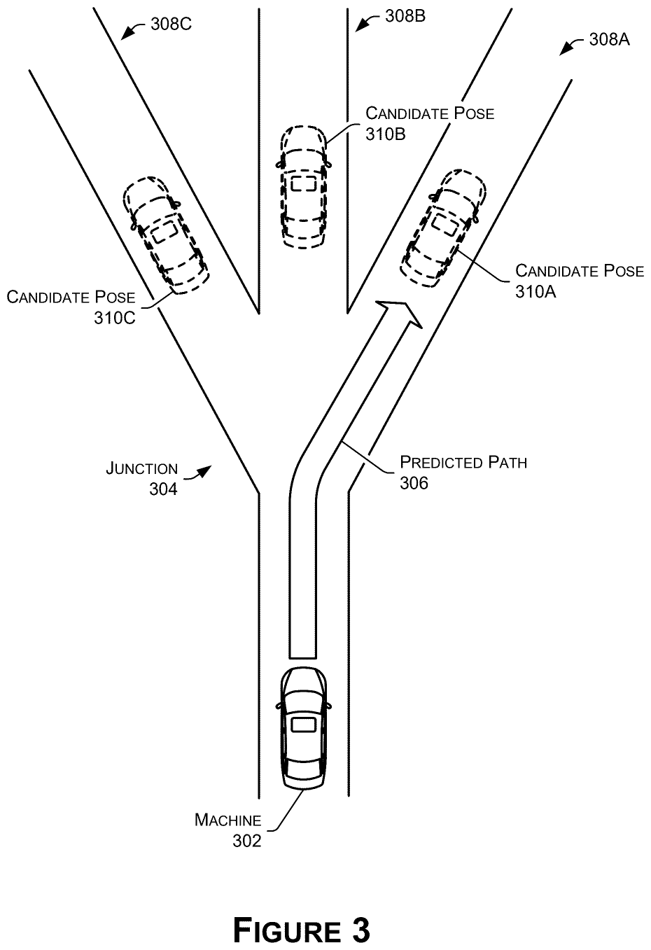

For instance, FIG. 3 illustrates an example visualization of candidate poses that may be determined and tracked for a machine, in accordance with some embodiments of the present disclosure. In the example of FIG. 3, a machine 302 (which may correspond to the autonomous vehicle 1000) is approaching a junction 304 that includes multiple successor road segments, and a predicted path 306 of the machine 302 is that the machine will turn right at the junction 304 onto a first successor road segment 308A. According to the techniques of the present disclosure, based on the machine passing through the junction 304, the tracker initializer 106 may initialize multiple trackers at candidate poses along the successor road segments. For instance, a first tracker may be initialized to track a first candidate pose 310A of the machine 302 along the first successor road segment 308A, a second tracker may be initialized to track a second candidate pose 310B of the machine 302 along a second successor road segment 308B, and a third tracker may be initialized to track a third candidate pose 310C of the machine 302 along the third successor road segment 308C. The candidate poses 310A-310C may correspond to the candidate poses 134 in the example of FIG. 1. In some examples, because the first successor road segment 308A corresponds to the predicted path 306 of the machine 302, the first tracker for the first candidate pose 310A may not need to be initialized. Instead, the tracker may, in at least some examples, be the same tracker that was used for tracking the location of the machine 302 along the road segment leading up to the junction 304.

Referring back to the example of FIG. 1, the process 100 may include the scoring component 110 computing scores for each of the trackers 108 and/or candidate poses 134 of the machine subsequent to the junction. The scores may be indicative of which candidate pose of the candidate poses 134 corresponds to the actual location of the machine. In some examples, the scoring component 110 may compute a plurality of scores for each of the trackers 108 and/or candidate poses 134 over a period of time (e.g., compute a new score for each tracker at each timestep, epoch, etc.) and aggregate the scores for each tracker and/or candidate pose to determine the highest score. In some examples, values of the scores may be computed using the same or similar measurements (e.g., input data 120) used to update the states of the Kalman filters of the trackers 108.

For instance, FIGS. 4A-4C illustrate examples associated with scoring the candidate poses of the machine from the example of FIG. 3, in accordance with some embodiments of the present disclosure. For the purpose of explaining FIGS. 4A-4C, assume that in the example of FIG. 3, the machine 302 actually traversed the predicted path 306 and turned right at the junction 304 to proceed onto the first successor road segment 308A.

Referring first to FIG. 4A, a relative motion 402 and a global motion 404 of the machine 302 is illustrated with respect to the first candidate pose 310A of the machine along the first successor road segment 308A. As shown, a geometry of the relative motion 402 and a geometry of the global motion 404 align with the geometry of the road segments and the previous location 406 of the machine 302. In such a scenario when there is a strong correlation of alignment between the relative motion 402, the global motion 404, and the roadway geometry between the previous location 406 of the machine 302 and the candidate pose, the scoring component 110 may compute a relatively high score for the first candidate pose 310A.

Referring now to FIG. 4B, the relative motion 402 and the global motion 404 of the machine 302 is illustrated with respect to the second candidate pose 310B of the machine 302 along the second successor road segment 308B. As shown, the geometry of the relative motion 402 deviates from the previous location 406 of the machine 302 when the relative motion 402 is aligned with the second candidate pose 310B. Additionally, because the global motion 404 is with respect to a coordinate system (e.g., GPS coordinate system), the geometry/orientation of the global motion 404 may remain constant regardless of the candidate pose. In other words, the global motion 404 may be overlaid on the map at its GPS location(s), and does not need to be determined relative to the pose of the machine 302 as does the relative motion 402. As such, the geometry of the global motion 404 deviates from the second candidate pose 310B, as shown. In such scenarios as shown in the example of FIG. 4B, when there is a weak correlation of alignment between the relative motion 402, the global motion 404, and the roadway geometry between the previous location 406 of the machine 302 and the second candidate pose 310B, the scoring component 110 may compute a relatively low score for the second candidate pose 310B, which may indicate that the actual pose of the machine 302 likely does not correspond to the second candidate pose 310B.

Referring now to FIG. 4C, the relative motion 402 and the global motion 404 of the machine 302 is illustrated with respect to the third candidate pose 310C of the machine 302 along the third successor road segment 308C. As shown, the geometry of the relative motion 402 deviates from the previous location 406 of the machine 302 when the relative motion 402 is aligned with the third candidate pose 310C. Additionally, the geometry of the global motion 404 fails to align with the third candidate pose 310C, as shown. In such scenarios as shown in the example of FIG. 4C, when there is a weak correlation of alignment between the relative motion 402, the global motion 404, and the roadway geometry between the previous location 406 of the machine 302 and the third candidate pose 310C, the scoring component 110 may compute a relatively low score for the third candidate pose 310C, which may indicate that the actual pose of the machine 302 likely does not correspond to the third candidate pose 310C.

Referring back to the example of FIG. 1, the process 100 may include the selection component 112 determining which candidate pose of the candidate poses 134 corresponds to the actual pose of the machine, and selecting a tracker of the trackers 108 to use for tracking the pose or location of the machine along a current road segment. In some examples, the prevailing candidate pose may be selected based on the scores of the candidate poses 134 tracked by each of the trackers 108. Additionally, or alternatively, the prevailing candidate pose may be selected based on an alignment between the geometry of the relative motion and/or global motion of the machine and a previous location of the machine and the candidate pose being stronger than a threshold amount of alignment. For instance, if the tips and tails of the relative motion and/or global motion of the machine match up or align with the previous location of the machine and the candidate pose of the machine, the candidate pose may be selected as the actual pose of the machine without necessarily needing to compute scores.

In some examples, the selection component 112 may evaluate the scores computed by the scoring component 110 to determine the tracker or candidate pose that has the highest score, as well as whether that score is greater than the other score(s) by more than a threshold. For instance, and with reference to the example of FIG. 3, the selection component 112 may determine that a score(s) associated with the first candidate pose 310A is greater than the scores associated with the second candidate pose 310B and the third candidate pose 310C. In such an example, the selection component 112 may determine that the location/pose of the machine 302 corresponds to the first candidate pose 310A based at least on the first candidate pose 310A having the greatest score. Additionally, in some examples, the selection component 112 may determine whether one or more differences between the score of the first candidate pose 310A and the scores of the second and third candidate poses meet or exceed the threshold, and the determination that the location/pose of the machine corresponds to the first candidate pose 310A may be further based on the difference(s) meeting or exceeding the threshold.

In some examples, the selection component 112 may evaluate the scores over a period of time as the scores are continuously recomputed and/or aggregated, and once one of the scores associated with one of the candidate poses 134 is determined to be greater than the other scores by more than the threshold, the selection component 112 may set the tracker to the prevailing candidate pose and remove/terminate the other trackers for the other candidate poses. For instance, in the example of FIG. 3, if the first candidate pose 310A is the prevailing pose, then the selection component 112 may cause the trackers associated with the second candidate pose 310B and the third candidate pose 310C to be terminated. In some examples, if the machine travels more than a threshold distance and/or for more than a threshold period of time with multiple candidate poses and trackers, and none of the scores meet or exceed the threshold, the selection component 112 may mark the localization result as unavailable.

In some examples, the path localization system 102 may use the selected tracker to track the location of the machine, and the path localization system 102 may generate the localization data 132 based on the outputs of the selected tracker. In some examples, the localization data 132 may indicate the specific road segment the machine is using after the junction, the location of the machine along that road segment (e.g., an offset of the machine along the road segment relative to a beginning or end of the road segment), a confidence associated with the localization result, and/or the like. In some examples, the localization data 132 may be sent to one or more of the drive stack components 104, and the drive stack components 104 may use the localization data 132 as an input to perform various processes associated with the machine.

For instance, the mapping component 114 may use the localization data 132 to determine whether to update a cached map of the environment. For instance, as described above and herein, as the machine traverses the environment, the machine may continuously receive updated map data representing portions of a map (e.g., a navigation map, SD map, etc.) to use to traverse the environment. As such, the machine may receive and temporarily store the relevant portions of the map, such as the map portions that correspond to the machine's current and/or future locations. In some examples, once a map portion is deemed to be valid (e.g., for the path of the machine), the mapping component 114 may cache the map portion until a new map portion is received and the newly received portion is also deemed to be valid. As such, the mapping component 114 may use the localization data 132 to determine whether a newly received map portion is valid and/or whether to update the cached map.

In such instances, if the newly received map portion does not include the road segment the machine is currently using in the localization data 132, the mapping component 114 may determine that the newly received map portion is invalid and refrain from updating the cached map. That is, the mapping component 114 may cause the machine to continue to rely on the cached map for navigation as the new map portion is invalid. As another example, if a new map portion does not include a road segment corresponding to the predicted path of the machine, or most probable path of the machine, the mapping component 114 may refrain from updating the cached map. If, however, the new map portion includes all relevant road segments, the mapping component 114 may determine the new map portion is valid and permit the cached map to be updated to the newly received map.

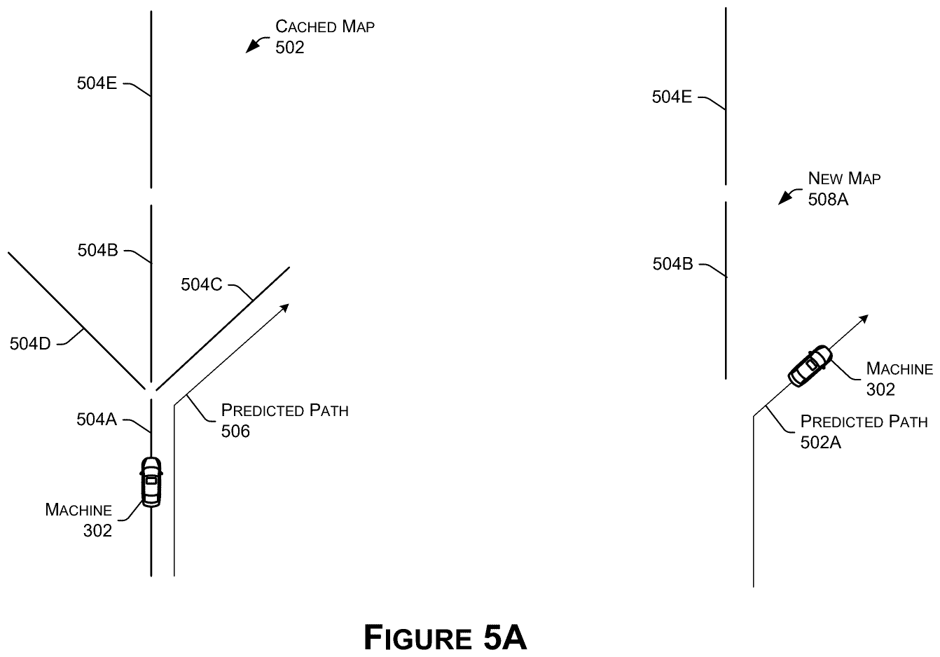

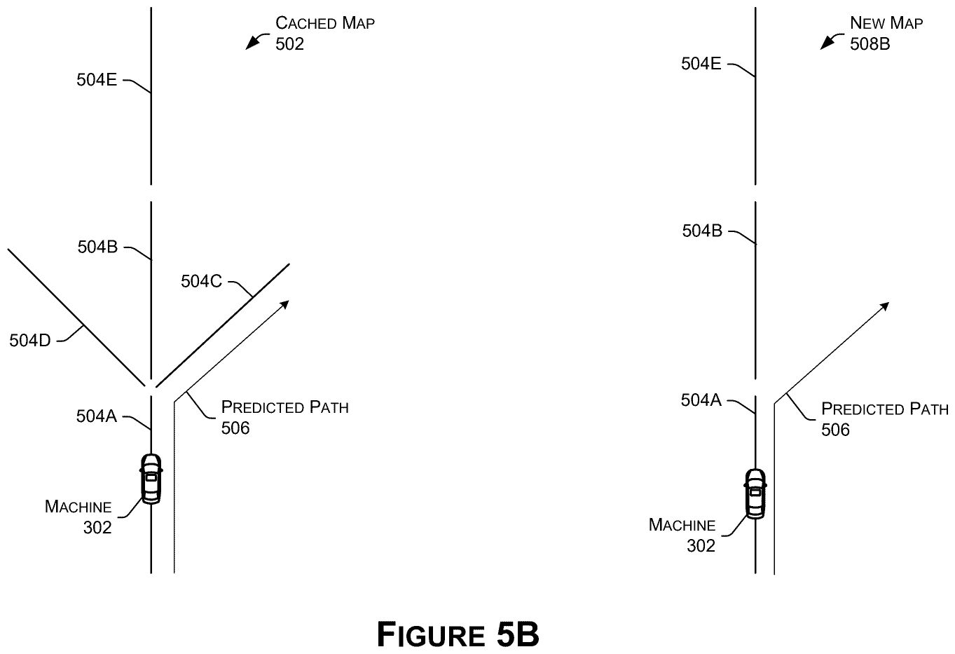

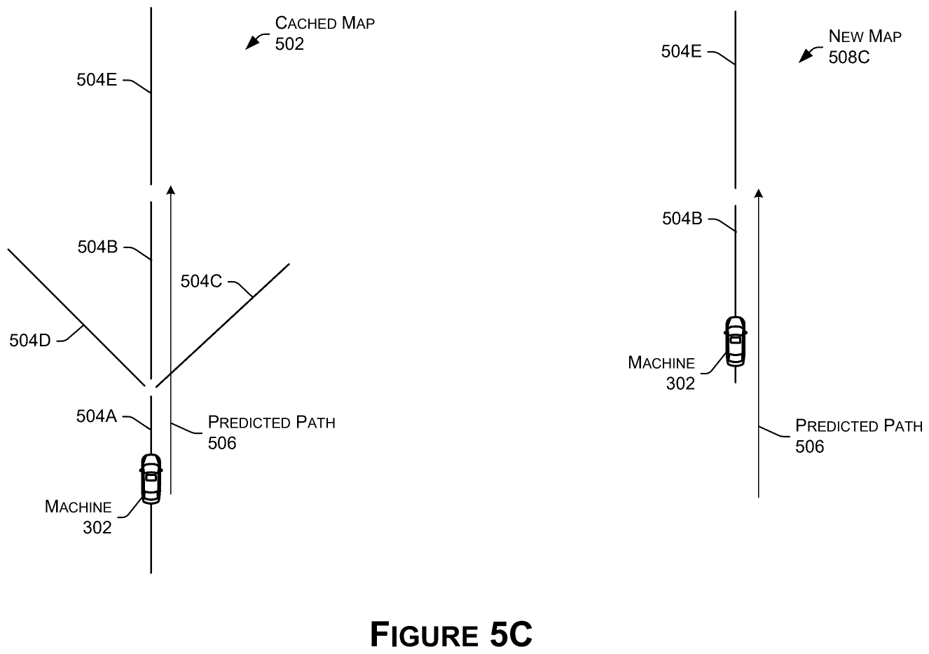

For instance, FIGS. 5A-5C illustrate examples associated with determining whether to update a cached map of an environment, in accordance with some embodiments of the present disclosure. Referring first to FIG. 5A, a cached map 502 may include a plurality of road segments 504A-504E representing a topology of a portion of a road network. When the new map 508A is received, the mapping component 114 may determine the new map 508A is invalid since the new map 508A does not include the road segment 504C corresponding to the predicted path 506 of the machine 302 and/or the localized position of the machine 302 along the road segment 504C. Similarly, in FIG. 5B, when the new map 508B is received, the mapping component 114 may determine that the new map 508B is invalid since the new map 508B does not include the road segment 504C corresponding to the predicted path 506 of the machine 302, even though the new map 508B includes the current road segment 504A the machine 302 is positioned on. However, in FIG. 5C, when the new map 508C is received, the mapping component 114 may determine that the new map 508C is valid since the new map 508C includes the road segments 504B and 504E that correspond to the predicted path 506 of the machine 302, as well as the road segment 504B the machine 302 is currently located on as indicated in the localization data 132. In such an example, the mapping component 114 may update the cached map 502 to correspond to the new map 508C.

Referring back to the example of FIG. 1, the process 100 may include the path prediction component 116 using the localization data 132 to determine a predicted path of the machine. For instance, the path prediction component 116 may use the localization data 132 to determine a current road segment the machine is traversing, and then determine the machines most probable path based on its current road segment and, in some instances, additional information (e.g., occupant intent data). Additionally, in some examples, the refinement component 118 may use the localization data 132 to refine one or more trajectories of the machine, one or more operational constraints of the machine, and/or any other operations performed by the machine. For instance, the refinement component 118 may use the localization data 132 to refine a trajectory of the machine, or to refine a maximum speed the machine is allowed to operate at. For instance, if the localization data 132 indicates the machine is traversing a road with high curvature, the refinement component 118 may lower the maximum operational speed of the machine at least while the machine is traversing the high curvature road.

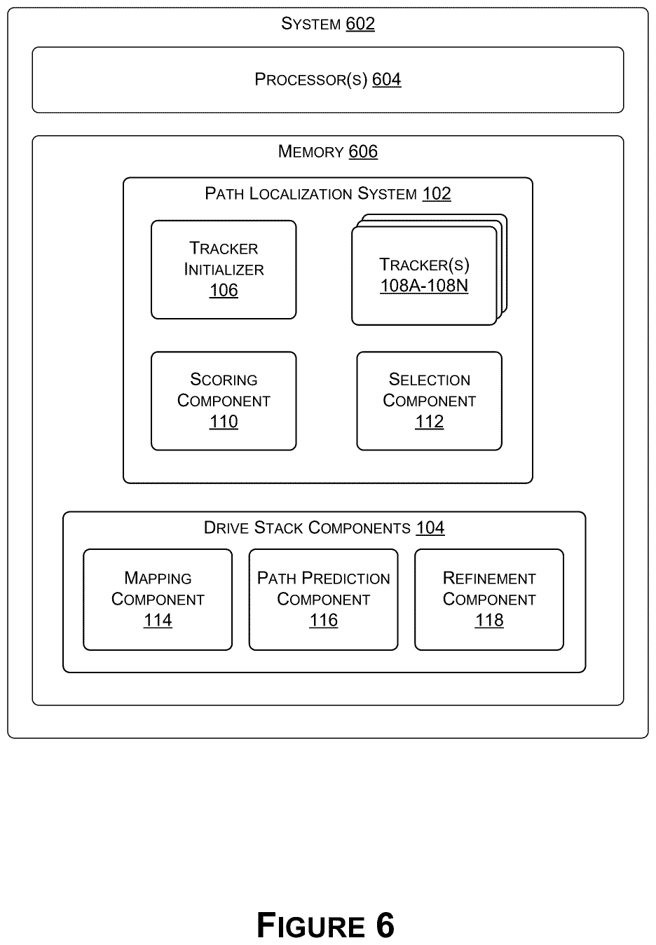

Referring now to FIG. 6, FIG. 6 illustrates an example of a system 600 that may perform one or more of the processes described herein, in accordance with some embodiments of the present disclosure. As shown, the system 602 (which may represent, and/or include, the example computing device(s) 1100 and/or the example data center 1200) may include one or more processors 604 (which may be similar to, and/or include, the CPUs 1106 and/or the GPUs 1108) and memory 606 (which may be similar to, and/or include, the memory 1104). For instance, the memory 806 may store one or more of the path localization system 102, including the tracker initializer 106, the tracker(s) 108A-108N, the scoring component 110, and/or the selection component 112, as well as the drive stack components 104, which may include the mapping component 114, the path prediction component 116, and/or the refinement component 118. Additionally, the processor(s) 804 may execute one or more of the path localization system 102, including the tracker initializer 106, the tracker(s) 108A-108N, the scoring component 110, and/or the selection component 112, and/or the drive stack components 104, including the mapping component 114, the path prediction component 116, and/or the refinement component 118 to perform one or more of the processes described herein.

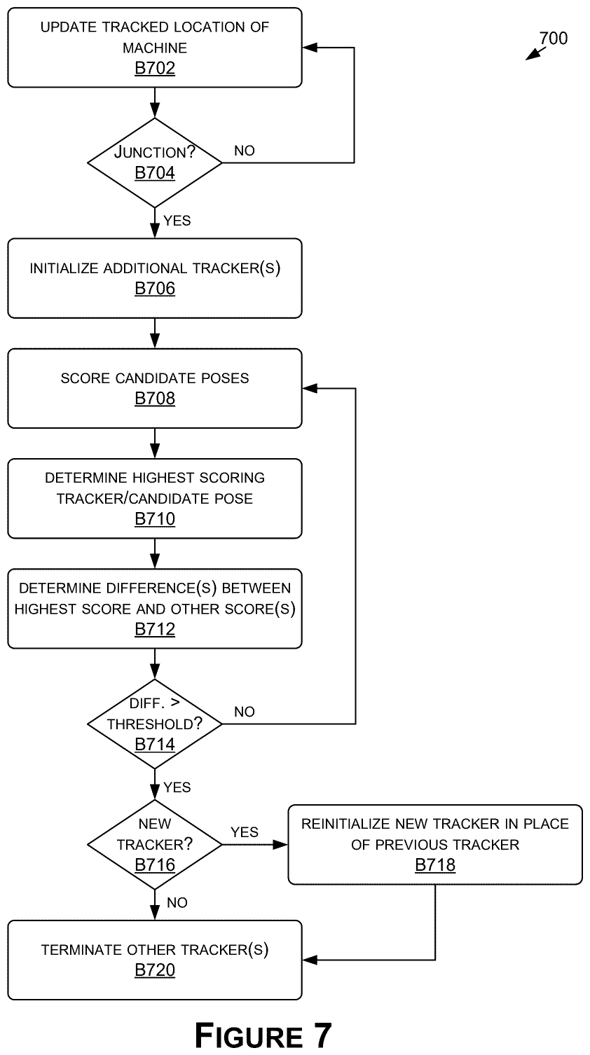

Now referring to FIGS. 7-9, each block of methods 700, 800, and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700, 800, and 900 are described, by way of example, with respect to FIG. 1. However, these methods may additionally or alternatively be executed by any one system, or any combination of systems, including, but not limited to, those described herein.

FIG. 7 is a flow diagram illustrating an example of a method for using path-specific trackers to localize a machine after a junction, in accordance with some embodiments of the present disclosure. The method 700, at block B702, may include updating a tracked location of a machine. For instance, a first tracker may update the tracked location of the machine using the input data 120. In some examples, the tracker may correspond to the tracker 202 and include a Kalman filter architecture that comprises at least a process model 204 and a measurement model 206. To update the tracked location of the machine, the tracker 202 may use the process model 204 to generate the predicted state(s) 208 based on the previous state(s) 210, and the measurement model 206 may use the input data 214 (e.g., sensor data, perception data, map data, etc.) to refine the predicted state(s) 208 and output the updated state(s) 212. The updated state(s) 212 may correspond to or be indicative of the tracked location of the machine. In some examples, updating the tracked location of the machine may include the Kalman filter updating state variables for an offset of the machine relative to a current road segment, updating a road segment identifier state variable, or updating a confidence state variable, the confidence associated with the offset and/or the road segment identifier.

The method 700, at block B704, may include determining whether the machine passed through a junction. For instance, based on updating the tracked location of the machine, the path localization system 102 and/or the tracker initializer 106 may determine whether the machine passed through the junction. In some examples, whether the machine passed through the junction may be determined if the road segment identifier state variable changed for the Kalman filter from a first road segment identifier (associated with the previous road segment) to a second road segment identifier (associated with a successor road segment), and/or if the offset value has moved past an end of the previous road segment. If, at block B704, it is determined that the machine has passed through the junction, the method 700 proceeds to block B706. Otherwise, if the machine has not passed through the junction, the method 700 proceeds back to block B702.

The method 700, at block B706, may include initializing an additional tracker(s). For instance, the tracker initializer 106 may initialize one or more of the trackers 108 at one or more of the candidate poses 134 of the machine. In some examples, the tracker initializer 106 may initialize an additional tracker for each successor road segment. For instance, while a junction for a 4-way stop may include or be associated with a total of four road segments, the 4-way stop junction may include three successor road segments since a machine may approach the junction using one of the road segments. As such, in some examples, the tracker initializer 106 may initialize a tracker on each of the three successor road segments. Additionally, or alternatively, in some instances the tracker may only need to initialize new trackers on two of the three successor road segments, as the initial tracker that tracked the machine along the non-successor road segment used to approach the junction may automatically move to one of the successor road segments. As such, in some examples, the tracker initializer may initialize less trackers than the total number of successor road segments.

The method 700, at block B708, may include scoring candidate poses. For instance, the scoring component 110 may compute scores for the candidate poses 134 using the input data 120. The scores may indicate which candidate pose corresponds to the actual pose or location of the machine, which may be further indicative of which successor road segment the machine is traversing. In some examples, the scoring component 110 may compute the candidate poses based on the relative motion or global motion of the machine, as described herein with respect to FIGS. 4A-4C. Additionally, or alternatively, the scoring component 110 may compute the candidate scores based on the perception data 128, which may indicate lane line markings and/or other road features. Additionally, or alternatively, the scoring component 110 may compute the candidate poses by comparing a yaw rate of the machine with the direction or geometry of the road segments. For instance, if the yaw rate of the machine is 30-degrees and one of the successor road segments is also 30-degrees, the scoring component 110 may compute a score value indicating a high-likelihood that the machine is operating on that road segment.

The method 700, at block B710, may include determining a highest scoring tracker/candidate pose. For instance, the selection component 112 may determine the highest scoring tracker of the trackers 108 and/or highest scoring pose of the candidate poses 134. In some examples, the selection component 112 may determine the highest scoring tracker/pose over a period of time by aggregating the respective scores of the respective trackers/poses over multiple iterations of the scoring component 110 computing the scores. For instance, the scoring component 110 may compute the scores at every timestamp, every time new input data 120 is received, and/or every epoch, and the selection component 112 may aggregate the scores to select the highest scoring tracker/candidate pose over the period of time.

The method 700, at block B712, may include determining a difference(s) between the highest score and the other score(s). For instance, the selection component 112 may determine the difference(s) between the highest score and the other score(s) so that the selected tracker/candidate pose is determined with a high-level of certainty. In some examples, the selection component 112 may determine the difference between the highest score and the next highest score, without computing multiple differences between each score. Additionally, or alternatively, the selection component 112 may compute the differences between every score.

The method 700, at block B714, may include determining whether the difference(s) meets or exceeds a threshold. For instance, the selection component 112 may determine whether the difference(s) meets or exceeds the threshold. In some instances, whether the difference(s) meets or exceeds the threshold may have a temporal aspect, and the difference(s) may need to meet or exceed the threshold for a threshold period of time. In various examples, the thresholds may be user defined or may be determined by the selection component 112 in real-time or near real-time. In this way, the selection component 112 may have the ability to change and adjust the thresholds as it sees fit. If, at block B714, it is determined that the difference(s) meets or exceeds the threshold, the method 700 may proceed to block B716. Otherwise, if the difference(s) does not meet or exceed the threshold, the method 700 proceeds back to block B708 and the scores may be recomputed, reaggregated, and re-evaluated.

The method 700, at block B716, may include determining whether the prevailing tracker is a new tracker (e.g., a tracker initialized after the junction). That is, in some instances, the selection component 112 may determine whether the tracker/candidate posed that prevailed (e.g., was the highest scoring by more than the threshold and/or for more than a threshold period of time) is the original tracker that tracked the location of the machine leading up to the junction, or if the tracker was a new tracker initialized by the tracker initializer 106 responsive to the machine passing through the junction. If, at block B716, it is determined the tracker is a new tracker, the method 700 proceeds to block B718. Otherwise, the method 700 proceeds to block B720.

The method 700, at block B718, may include reinitializing the new tracker in place of the previous tracker. For instance, the path localization system 102 may replace the original tracker that tracked the location of the machine leading up to the junction with the new, prevailing tracker initialized by the tracker initializer 106 responsive to the machine passing through the junction.

The method 700, at block B720, may include terminating the other tracker(s). For instance, the path localization system 102, or the tracker initializer 106, may terminate the non-prevailing tracker(s) or the tracker(s) that was not selected as having the highest score. In this way, once the location/pose of the machine is known or determined with high confidence, only one tracker may be used by the path localization system 102 to track the location of the machine. However, if the machine again passes through another junction, the method 700 may repeat from block 706 and more trackers may be initialized.

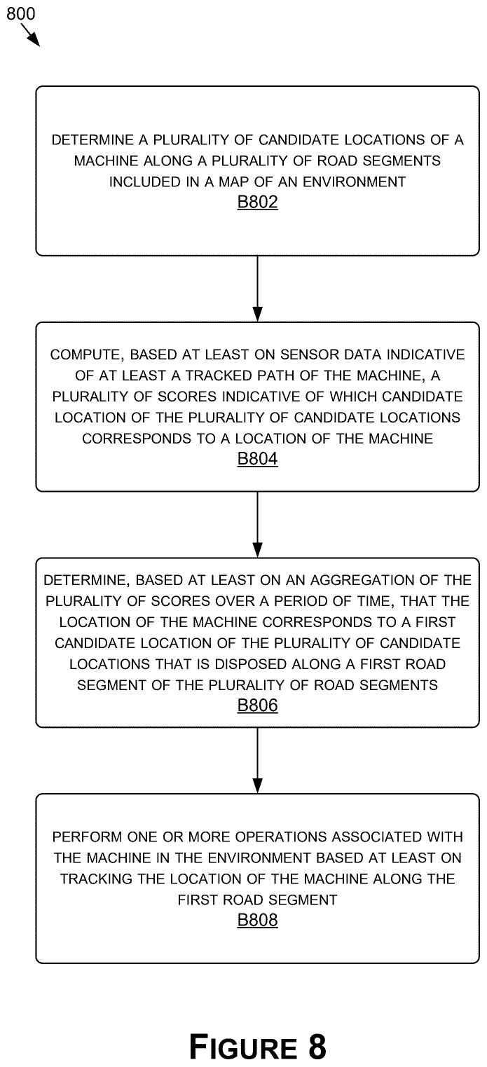

Referring now to FIG. 8, FIG. 8 is a flow diagram illustrating an example of a method 800 for determining a location of a machine based on scoring a plurality of candidate locations, in accordance with some embodiments of the present disclosure. The method 800, at block B802, may include determining a plurality of candidate locations of a machine along a plurality of road segments included in a map of an environment. For instance, the tracker initializer 106, the trackers 108, and/or the scoring component 110 may determine the plurality of candidate poses 134 of the machine along the plurality of road segments included in the map of the environment represented using the map data 124.

The method 800, at block B804, may include computing, based at least on sensor data indicative of at least a tracked path of the machine, a plurality of scores indicative of which candidate location of the plurality of candidate locations corresponds to a location of the machine. For instance, the scoring component 110 may use the input data 120 to compute the plurality of scores indicative of which candidate pose of the plurality of candidate poses 134 corresponds to the location of the machine.

The method 800, at block B806, may include determining, based at least on an aggregation of the plurality of scores over a period of time, that the location of the machine corresponds to a first candidate location of the plurality of candidate locations that is disposed along a first road segment of the plurality of road segments. For instance, the scoring component 110 and/or the selection component 112 may aggregate the plurality of scores over the period of time, and the selection component 112 may determine that the location of the machine corresponds to the first candidate pose of the plurality of candidate poses 134 that is disposed along the first road segment of the plurality of road segments.

The method 800, at block B808, may include performing one or more operations associated with the machine in the environment based at least on tracking the location of the machine along the first road segment. For instance, the drive stack components 104 may perform the operation(s) associated with the machine in the environment based at least on the localization data 132 indicating the location of the machine along the first road segment.

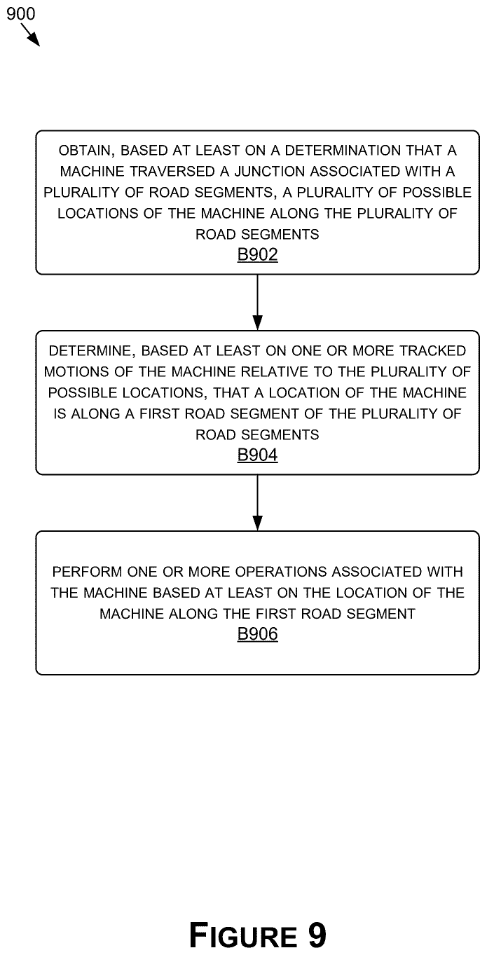

FIG. 9 is a flow diagram illustrating an example of a method 900 for determining a road segment a machine is using after passing through a junction, in accordance with some embodiments of the present disclosure. The method 900, at block B902, may include obtaining, based at least on a determination that a machine traversed a junction associated with a plurality of road segments, a plurality of possible locations of the machine along the plurality of road segments. For instance, the scoring component 110 may obtain the candidate poses 134 indicating the plurality of possible locations of the machine along the plurality of road segments.

The method 900, at block B904, may include determine, based at least on one or more tracked motions of the machine relative to the plurality of possible locations, that a location of the machine is along a first road segment of the plurality of road segments. For instance, the selection component 112 may determine that the location of the machine is along the first road segment of the plurality of road segments. The selection component 112 may select one of the trackers 108 corresponding to the location of the machine.

The method 900, at block B906, may include perform one or more operations associated with the machine based at least on the location of the machine along the first road segment. For instance, the drive stack components 104 may perform the operation(s) associated with the machine based at least on the localization data 132 indicating that the location of the machine is along the first road segment.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3—Level 5 of the autonomous driving levels. The vehicle 1000 may be capable of functionality in accordance with one or more of Level 1—Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark^{TM} (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: determining a plurality of candidate locations of a machine along a plurality of road segments included in a map of an environment, the plurality of road segments corresponding to a plurality of options for a path of the machine at one or more junctions; computing, based at least on sensor data indicative of at least a tracked path of the machine, a plurality of scores indicative of which candidate location of the plurality of candidate locations corresponds to a location of the machine; determining, based at least on an aggregation of the plurality of scores over a period of time, that the location of the machine corresponds to a first candidate location of the plurality of candidate locations that is disposed along a first road segment of the plurality of road segments; and performing one or more operations associated with the machine in the environment based at least on tracking the location of the machine along the first road segment.
B. The method as recited in paragraph A, further comprising: obtaining an updated version of the map of the environment; and determining, based at least on the location of the machine corresponding to the first candidate location, whether the updated version of the map is valid for tracking the path of the machine along the first road segment, wherein the performing of the one or more operations associated with the machine is further based at least on whether the updated version of the map is valid.
C. The method as recited in any one of paragraphs A-B, wherein the computing of the plurality of scores comprises: computing, using one or more heuristic scoring functions, one or more scores for each candidate location of the plurality of candidate locations; and aggregating the one or more scores for each candidate location over the period of time.
D. The method as recited in any one of paragraphs A-C, further comprising: determining at least one of: a relative trajectory of the machine based at least on the sensor data indicating at least one or more rotations and one or more translations of the machine between one or more timestamps; or a global trajectory of the machine based at least on the sensor data indicating at least one or more positional coordinates and one or more orientations of the machine at the one or more timestamps, wherein the tracked path of the machine corresponds to the at least one of the relative trajectory or the global trajectory.
E. The method as recited in any one of paragraphs A-D, wherein the computing of the plurality of scores is further based at least on one or more of: a plurality of curvatures associated with the plurality of road segments; a yaw rate associated with the machine; or a predicted path of the machine.
F. The method as recited in any one of paragraphs A-E, further comprising: determining that a first score associated with the first candidate location is greater than one or more second scores associated with one or more second candidate locations by more than a threshold, wherein the determining that the location of the machine corresponds to the first candidate location is based at least on the first score being greater than the one or more second scores by more than the threshold.
G. The method as recited in any one of paragraphs A-F, further comprising: determining, prior to the one or more junctions, a predicted path of the machine; determining, based at least on the location of the machine corresponding to the first candidate location that is disposed along the first road segment, that the path of the machine is different from the predicted path of the machine; and based at least on the path being different from the predicted path, initializing one or more Kalman filters for the tracking of the location of the machine along the first road segment.
H. A system comprising: one or more processors to: obtain, based at least on a determination that a machine traversed a junction associated with a plurality of road segments, a plurality of possible locations of the machine along the plurality of road segments; determine, based at least on one or more tracked motions of the machine relative to the plurality of possible locations, that a location of the machine is along a first road segment of the plurality of road segments; and perform one or more operations associated with the machine based at least on the location of the machine along the first road segment.
I. The system as recited in paragraph H, the one or more processors further to: compute, at one or more first instances of time, one or more first scores associated with the plurality of possible locations; and compute, at one or more second instances of time, one or more second scores associated with the plurality of possible locations; wherein the determination of the location of the machine is further based at least on an aggregation of the one or more first scores and the one or more second scores.
J. The system as recited in any one of paragraphs H-I, wherein the computation of at least one of the one or more first scores or the one or more second scores is further based at least on: a tracked path of the machine relative to one or more coordinate systems; a pose of the machine; a yaw rate of the machine; a plurality of curvatures associated with the plurality of road segments; a number of lanes associated with the plurality of road segments; or surface markings associated with the plurality of road segments.
K. The system as recited in any one of paragraphs H-J, the one or more processors further to: initialize, for the plurality of road segments, a plurality of trackers to track the plurality of possible locations of the machine; and based at least on the determination that the location of the machine is along the first road segment, terminate one or more of the plurality of trackers for tracking one or more of the plurality of possible locations along one or more second road segments of the plurality of road segments.
L. The system as recited in any one of paragraphs H-K, the one or more processors further to: initialize a Kalman filter to track one or more state variables indicative of the location of the machine along the first road segment, the one or more state variables including at least one of: an identifier corresponding to the first road segment; the location of the machine relative to at least one point along the first road segment; or a confidence score corresponding to the location of the machine.
M. The system as recited in any one of paragraphs H-L, the one or more processors further to: determine that a first score associated with a first possible location of the plurality of possible locations is greater than one or more second scores associated with one or more second possible locations of the plurality; and determine that the location of the machine corresponds to the first possible location based at least on the first score being greater than the one or more second scores.
N. The system as recited in any one of paragraphs H-M, the one or more processors further to: determine whether one or more differences between the first score and the one or more second scores meet or exceed a threshold, wherein the determination that the location of the machine corresponds to the first possible location is further based at least on the one or more differences meeting or exceeding the threshold.

O. The system as recited in any one of paragraphs H-N, the one or more processors further to: determine that the machine traversed the junction based at least on map data representing a map of an environment; obtain an updated version of the map data; and determine, based at least on the location of the machine along the first road segment, whether the updated version of the map data is valid.
P. The system as recited in any one of paragraphs H-O, the one or more processors further to: initialize one or more Kalman filters to track one or more locations of the machine relative to one or more road segments using one or more state variables; compute, based at least on at least one of sensor data or perception data, one or more updated state variables of the one or more Kalman filters indicative of one or more updated locations of the machine; and determine, using the one or more updated locations of the machine, that the machine traversed the junction associated with the plurality of road segments.
Q. The system as recited in any one of paragraphs H-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system implementing one or more machine learning models as an inference microservice using one or more operating system (OS)-level virtualization packages; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
R. One or more processors comprising: processing circuitry to evaluate one or more path localization algorithms within a simulation environment rendered using one or more light transport simulation algorithms, the one or more path localization algorithms to determine a location of a virtual machine in the simulation environment by initializing one or more trackers to track one or more possible locations of the virtual machine along one or more road segments in the simulation environment subsequent to the virtual machine traversing one or more junctions from which the one or more road segments diverge.
S. The one or more processors as recited in paragraph R, wherein the simulation is generated, at least in part, using a three-dimensional (3D) content collaboration platform for 3D assets.
T. The one or more processors as recited in any one of paragraphs R-S, wherein the 3D content collaboration platform for 3D assets uses universal scene descriptor (USD) data for managing one or more attributes of a simulated environment associated with the simulation.

What is claimed is:

1. A method comprising:
determining a plurality of candidate locations of a machine along a plurality of road segments included in a map of an environment, the plurality of road segments corresponding to a plurality of options for a path of the machine at one or more junctions;
computing, based at least on sensor data indicative of at least a tracked path of the machine, a plurality of scores indicative of which candidate location of the plurality of candidate locations corresponds to a location of the machine;
determining, based at least on an aggregation of the plurality of scores over a period of time, that the location of the machine corresponds to a first candidate location of the plurality of candidate locations that is disposed along a first road segment of the plurality of road segments; and
performing one or more operations associated with the machine in the environment based at least on tracking the location of the machine along the first road segment.

2. The method of claim 1, further comprising:
obtaining an updated version of the map of the environment; and
determining, based at least on the location of the machine corresponding to the first candidate location, whether the updated version of the map is valid for tracking the path of the machine along the first road segment,
wherein the performing of the one or more operations associated with the machine is further based at least on whether the updated version of the map is valid.

3. The method of claim 1, wherein the computing of the plurality of scores comprises:
computing, using one or more heuristic scoring functions, one or more scores for each candidate location of the plurality of candidate locations; and
aggregating the one or more scores for each candidate location over the period of time.

4. The method of claim 1, further comprising:
determining at least one of:
a relative trajectory of the machine based at least on the sensor data indicating at least one or more rotations and one or more translations of the machine between one or more timestamps; or
a global trajectory of the machine based at least on the sensor data indicating at least one or more positional coordinates and one or more orientations of the machine at the one or more timestamps,
wherein the tracked path of the machine corresponds to the at least one of the relative trajectory or the global trajectory.

5. The method of claim 1, wherein the computing of the plurality of scores is further based at least on one or more of:
a plurality of curvatures associated with the plurality of road segments;
a yaw rate associated with the machine; or
a predicted path of the machine.

6. The method of claim 1, further comprising:
determining that a first score associated with the first candidate location is greater than one or more second scores associated with one or more second candidate locations by more than a threshold,
wherein the determining that the location of the machine corresponds to the first candidate location is based at least on the first score being greater than the one or more second scores by more than the threshold.

7. The method of claim 1, further comprising:
determining, prior to the one or more junctions, a predicted path of the machine;
determining, based at least on the location of the machine corresponding to the first candidate location that is disposed along the first road segment, that the path of the machine is different from the predicted path of the machine; and
based at least on the path being different from the predicted path, initializing one or more Kalman filters for the tracking of the location of the machine along the first road segment.

8. A system comprising:
one or more processors to:
obtain, based at least on a determination that a machine traversed a junction associated with a plurality of road segments, a plurality of possible locations of the machine along the plurality of road segments;
determine, based at least on one or more tracked motions of the machine relative to the plurality of possible locations, that a location of the machine is along a first road segment of the plurality of road segments; and
perform one or more operations associated with the machine based at least on the location of the machine along the first road segment.

9. The system of claim 8, the one or more processors further to:
compute, at one or more first instances of time, one or more first scores associated with the plurality of possible locations; and
compute, at one or more second instances of time, one or more second scores associated with the plurality of possible locations;
wherein the determination of the location of the machine is further based at least on an aggregation of the one or more first scores and the one or more second scores.

10. The system of claim 9, wherein the computation of at least one of the one or more first scores or the one or more second scores is further based at least on:
a tracked path of the machine relative to one or more coordinate systems;
a pose of the machine;
a yaw rate of the machine;
a plurality of curvatures associated with the plurality of road segments;
a number of lanes associated with the plurality of road segments; or
surface markings associated with the plurality of road segments.

11. The system of claim 8, the one or more processors further to:
initialize, for the plurality of road segments, a plurality of trackers to track the plurality of possible locations of the machine; and
based at least on the determination that the location of the machine is along the first road segment, terminate one or more of the plurality of trackers for tracking one or more of the plurality of possible locations along one or more second road segments of the plurality of road segments.

12. The system of claim 8, the one or more processors further to:
initialize a Kalman filter to track one or more state variables indicative of the location of the machine along the first road segment, the one or more state variables including at least one of:
an identifier corresponding to the first road segment;
the location of the machine relative to at least one point along the first road segment; or
a confidence score corresponding to the location of the machine.

13. The system of claim 8, the one or more processors further to:
determine that a first score associated with a first possible location of the plurality of possible locations is greater than one or more second scores associated with one or more second possible locations of the plurality; and
determine that the location of the machine corresponds to the first possible location based at least on the first score being greater than the one or more second scores.

14. The system of claim 13, the one or more processors further to:
determine whether one or more differences between the first score and the one or more second scores meet or exceed a threshold,
wherein the determination that the location of the machine corresponds to the first possible location is further based at least on the one or more differences meeting or exceeding the threshold.

15. The system of claim 8, the one or more processors further to:
determine that the machine traversed the junction based at least on map data representing a map of an environment;
obtain an updated version of the map data; and
determine, based at least on the location of the machine along the first road segment, whether the updated version of the map data is valid.

16. The system of claim 8, the one or more processors further to:
initialize one or more Kalman filters to track one or more locations of the machine relative to one or more road segments using one or more state variables;
compute, based at least on at least one of sensor data or perception data, one or more updated state variables of the one or more Kalman filters indicative of one or more updated locations of the machine; and
determine, using the one or more updated locations of the machine, that the machine traversed the junction associated with the plurality of road segments.

17. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system implementing one or more machine learning models as an inference microservice using one or more operating system (OS)-level virtualization packages;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
processing circuitry to evaluate one or more path localization algorithms within a simulation environment rendered using one or more light transport simulation algorithms, the one or more path localization algorithms to determine a location of a virtual machine in the simulation environment by initializing one or more trackers to track one or more possible locations of the virtual machine along one or more road segments in the simulation environment subsequent to the virtual machine traversing one or more junctions from which the one or more road segments diverge.

19. The one or more processors of claim 18, wherein the simulation is generated, at least in part, using a three-dimensional (3D) content collaboration platform for 3D assets.

20. The one or more processors of claim 19, wherein the 3D content collaboration platform for 3D assets uses universal scene descriptor (USD) data for managing one or more attributes of a simulated environment associated with the simulation.
